(19) United States
(12) Patent Application Publication
(10) Pub. No.: US 2018/0074163 A1
(43) Pub. Date: Mar. 15, 2018

(54) METHOD AND SYSTEM FOR POSITIONING SOUND SOURCE BY ROBOT

(71) Applicant: Nanjing AvatarMind Robot Technology Co., Ltd., Nanjing (CN)

(72) Inventors: Tingliang LI, Nanjing (CN); Zhen LI, Nanjing (CN)

(21) Appl. No.: 15/806,301

(22) Filed: Nov. 7, 2017

Related U.S. Application Data
(63) Continuation of application No. PCT/CN2017/100777, filed on Sep. 6, 2017.

(30) Foreign Application Priority Data
Sep. 8, 2016 (CN) 201610810766.5

(51) Int. Cl. G01S 5/22

(52) U.S. Cl. CPC G01S 5/22; B25J 19/026

(57) ABSTRACT

Disclosed are a method and system for positioning a sound source by a robot. With a combination of delay estimation and power spectrum intensity, the approximate direction of the sound source is estimated according to the power spectrum intensities received by the sound source acquisition apparatuses and the spatial directions of the sound source acquisition apparatuses. As such, the approximate direction of the sound source may be accurately estimated. The power spectrum intensity comparison refers to calculating an average power spectrum intensity of the sound source acquisition apparatuses within a specific frequency interval, and the average power spectrum intensity is inversely proportion to the distance from the sound source to the sound source acquisition apparatuses.

This application is an US national stage application of the international patent application PCT/CN2017/100777, filed on Sep. 6, 2017, which is based upon and claims priority of Chinese Patent Application No. 201610810766.5, filed before Chinese Patent Office on Sep. 8, 2016 and entitled “METHOD AND SYSTEM FOR POSITIONING SOUND SOURCE BY ROBOT”, the entire contents of which are incorporated herein by reference.

### TECHNICAL FIELD

The present disclosure relates to the field of robot auditory technologies, and in particular, relates to a method and system for positioning a sound source by a robot.

### BACKGROUND

High directionality monophonic microphones generally pick up signals from one way, whereas microphone array systems are capable of picking up signals from multiple ways. Although the microphone array acquires data of a single target, due to different positions of the microphones in the array, the data acquired by the microphone array is definitely somewhat different in terms of both time domain and frequency domain. A plurality of microphones forms a microphone array, digital signals are then processed, and by means of data fusion of signals from multiple ways, desired information may be extracted, and the position of a sound source may be estimated. At present, a generally used sound source positioning method is delay estimation. Firstly, sensors receive signals, and the signals are digitalized by using a computer. Afterwards, the data is processed based on a mathematical method, that is, a relative delay of the signals when the signals reach the sensors is estimated. Finally, by using this delay estimated value, the position of the sound source is determined by means of mathematical calculation. Many algorithms are available for delay estimation. In practice, a widely employed and simple algorithm is the generalized cross-correlation function method. The basic principles of the generalized cross-correlation function method are as follows: a mutual spectrum between two groups of signals is calculated, then different weighting calculations are performed in the frequency domain, and finally an inverse transformation is made to the time domain to obtain a cross-correlation function between the two groups of signals, wherein the time corresponding to an extreme value of the cross-correlation function is the delay between the two groups of signals. Typically, two independent delay estimation values are needed, and in a three-dimensional scenario, three independent delay estimation values are needed. Each delay estimation value corresponds to one quadratic or cubic equation. The coordinates of the sound source may be obtained by means of solving the equations. However, the coordinates are also estimated coordinates and are subjected to some errors. Many simulation studies have proven that this algorithm is applicable to positioning of a single sound source, and in a complicated noise environment, some other sound positioning methods need to be incorporated for a comprehensive judgment to ensure positioning accuracy.

The sound source positioning technology based on the microphone array has been extensively used. With the advancement of the robot technology, people desire intelligent robots to provide more services in their daily life. In the past, people are more concerned about the motion system and visual system in the development of the intelligent robot technology, but place less importance on communication and interaction between human and robots. Therefore, it is very necessary to establish an effective communication bridge between human and robots. For example, the auditory mechanism of the robot is capable of making a response to an ambient sound, and thus robots are employed to detect a sound target. In addition, the auditory system also draws sensory attention from robots, and such multiple-information fuse technology has become an important research subject. The auditory system of the robot for use in man-machine interaction is basically based on the sound source positioning technology. When a robot user conducts language communication with an intelligent robot, the robot is capable of quickly detecting the user or finding the position of the sound source. Besides, the robot is further capable of finding the sound source via sound signals in a dark environment, or finding a dangerous sound source in a complicated environment. In a man-machine interaction device, the performance of the auditory system is a critical remark of the development of the intelligent degree. The accuracy of the sound source positioning is an important factor affecting the performance of the auditory system.

### SUMMARY

The technical problem to be solved by the present disclosure is to provide a method and system for positioning a sound source by a robot, which implements more accurate positioning of a sound source by the robot.

The present disclosure provides a method for positioning a sound source by a robot. The method includes the following steps:

S100: monitoring a plurality of sound source signals acquired by various sound source acquisition apparatuses;

S200: when sound intensities of some sound source signals reach a predetermined sound intensity threshold, converting analog signals of the sound source signals with the sound intensities being greater than the predetermined sound intensity threshold into to-be-processed digital signals corresponding to the sound source signals;

S300: respectively calculating actual power spectrums of the to-be-processed digital signals corresponding to the sound source signals;

S400: combining each two sound source signals of the various sound source signals to obtain a plurality of sound signal combinations;

S500: calculating a delay between two sound source signals in each of the sound source signal combinations; and

S600: calculating sound source coordinates corresponding to the sound source signals according to the delays between the two sound source signals in the sound source signal combinations, a predetermined sound propagation speed and coordinates of the various sound source acquisition apparatuses.

Further step S300 includes the following steps: S310 respectively calculating spectrums of the sound source signals according to the to-be-processed digital signals corresponding to the sound source signals; and S320 respectively calculating actual power spectrums of the sound source signals according to the spectrums of the sound source signals.

Further, in step S310, the spectrum of one of the sound source signals is calculated using the following formula:

X(n)=a₀*s(n)+a₁*s(n−1)+ . . . +aₙ₋₁*s(n−N−1) (1);

wherein in formula (1), N represents a predetermined sampling point quantity corresponding to one of the sound source signals, s(n) represents a to-be-processed digital signal corresponding to one of the sound source signals corresponding to the n^{th} sampling point, X(n) is a filter signal obtained after FIR filtering is performed for the to-be-processed digital signal corresponding to one of the sound source signals corresponding to the n^{th} sampling point, and a₀-aₙ₋₁ represents n predetermined filter coefficients;

$$\begin{matrix}W ( n ) = \{ \begin{matrix}0.54 - 0.46 cos ( 2 π \frac{n}{N - 1} ) , 0 \leq n \leq ( N - 1 ) \\ 0 , n = else\end{matrix} ; & ( 2 ) \\ {X}_{N} ( n ) = X ( n ) * W ( n ) ; & ( 3 )\end{matrix}$$

wherein in formula (2) and formula (3), W(n) represents a window function, X(n) represents a filter signal obtained after FIR filtering is performed for the to-be-processed digital signal corresponding to one of the sound source signals corresponding to the n^{th} sampling point, N represents a predetermined sampling point quality corresponding to one of the sound source signals, X_{N}(n) represents a finite-length filter signal obtained after windowing is performed for the filter signal corresponding to the n^{th} sampling point in one of the sound source signals;

$${X}_{N} ( {e}^{i ω} ) = {\sum }_{n = 0}^{N - 1} {x}_{N} ( n ) {e}^{- i ω n} ; \qquad ( 4 )$$

wherein in formula (4), X_{N}(n) represents a finite-length filter signal obtained after windowing is performed for the filter signal corresponding to the n^{th} sampling point in one of the sound source signals, and X_{N}(e^{iω}) represents a spectrum corresponding to one of the sound source signals;

in step S320, the actual power spectrum of one of the sound source signals is calculated using the following formula:

$${S}_{x} ( {e}^{i ω} ) = \frac{1}{N} {\vert {X}_{N} ( {e}^{i ω} ) \vert}^{2} ; \qquad ( 5 )$$

wherein in formula (5), N represents a predetermined sampling point quality corresponding to one of the sound source signals, X_{N}(e^{iω}) represents a spectrum corresponding to one of the sound source signals, and Sₓ(e^{iω}) represents an actual power spectrum corresponding to one of the sound source signals.

Further, step S500 includes the following steps: S510 calculating a mutual power spectrum between the two sound source signals in each of the sound source signal combinations according to actual power spectrums of the two sound source signals in the sound source signal combinations; S520 calculating a frame cross-correlation function between the two sound source signals in each of the sound source signal combinations according to the mutual power spectrums of the sound source signal combinations; and S530 calculating a delay between the two sound source signals in each of the sound source signal combinations according to the frame cross-correlation functions between the two sound source signals in the sound source signal combinations.

Further, in step S510, the mutual power spectrum between the two sound source signals in each of the sound source signal combinations is calculated using the following formula:

$${G}_{lm} ( ω ) = {X}_{l} ( ω ) {X}_{m}^{*} ( ω ) = {abG}_{ss} ( ω ) {e}^{- j ω ( {τ}_{l} - {τ}_{m} )} + {G}_{{n}_{l} {n}_{{ }_{m}}} ( ω ) ; \qquad ( 6 )$$

wherein in formula (6), Xₗ(ω) represents an actual power spectrum of one sound source signal in one of the sound source signal combination, Xₘ*(ω) represents an actual power spectrum of another sound source signal in the sound source signal combinations, Gₗₘ(ω) represents a mutual power spectrum between two sound source signals in the sound source signal combination, Gₛₛ(ω)e^{-jω(τ}^{ₗ}^{-τ}^{ₘ}⁾ represents a power spectrum between two sound source signals in the sound source signal combination,

$${G}_{{n}_{l} {n}_{{ }_{m}}} ( ω )$$

represents a mutual spectrum of an additive noise signal of two sound source signals in the sound source signal combination, and a and b are predetermined constants.

Further, in step S520, the frame cross-correlation function the two sound source signals in each of the sound source signal combinations is calculated using the following formula:

$${R}_{lm}^{g} ( τ ) = {\int }_{∞}^{∞} φ ( ω ) {G}_{lm} ( ω ) {e}^{j ωτ} d ω ; \qquad ( 7 )$$

wherein in formula (7), φ(ω) represents a weighting function, Rₗₘ^{g}(τ) represents a frame cross-correlation function between two sound source signals of one of the sound source signal combinations, and Gₗₘ(ω) represents a mutual power spectrum between two sound source signals of the sound source signal combination.

Further, in step S530, the delay between the two sound source signals in each of the sound source signal combinations is calculated using the following formula:

φ(ω)=1/|Gₗₘ(ω)| (8)

wherein in formula (8), Gₗₘ(ω) represents a mutual power spectrum between two sound source signals in each of the sound source signal combinations;

according to the φ(ω) weighting function, the frame cross-correlation function of each of the sound source signal combinations is:

$${R}_{lm}^{g} ( τ ) = {\int }_{∞}^{∞} \frac{{G}_{lm} ( ω )}{\vert {G}_{lm} ( ω ) \vert} {e}^{j ωτ} d ω = ab δ ( τ - ( {τ}_{l} - {τ}_{m} ) ) ; \qquad ( 9 )$$

wherein in formula (9), a and b are predetermined constants, δ(τ−(τₗ−τₘ)) represents a delay function between two sound source signals in each of the sound source signal combinations, τ represents a delay between two sound source signals in each of the sound source signal combinations, τₗ represents the time when one sound source signal in the sound source signal combination reaches a corresponding sound source acquisition apparatus, τₘ represents the time when the other sound source signal in the sound source signal combination reaches a corresponding sound source acquisition apparatus, and when the frame cross-correlation function takes a peak value, τ=τₗ−τₘ.

Further, in step S600, the coordinates of the sound sources corresponding to the sound source signals are calculated using the following formulae:

(Xₖ−X)²+(Yₖ−Y)²+(Zₖ−Z)²=Ctₖ² (10)

τₚ=tₚₗ−tₚₘ (11)

wherein K sound source acquisition apparatus are configured, Xₖ represents X-coordinate of the k^{th} sound source acquisition apparatus of all the sound source acquisition apparatuses, Yₖ represents Y-coordinate of the k^{th} sound source acquisition apparatus of all the sound source acquisition apparatuses, Zₖ represents Z-coordinate of the k^{th} sound source acquisition apparatus of all the sound source acquisition apparatuses, k is a natural number and is not greater than the total number of sound source acquisition apparatuses, tₖ represents the time when the k^{th} sound source signal reaches a corresponding sound source acquisition apparatus;

C represents a predetermined sound propagation speed;

each two sound source signals of K sound source signals corresponding to the K sound source acquisition apparatuses are combined to obtain P sound source signal combinations, τₚ represents a delay between two sound source signals in the p^{th} sound source signal combination of the P sound source signal combinations, tₚₗ represents the time when one sound source signal in the p^{th} sound source signal combination of the P sound source signal combinations reaches a corresponding sound source acquisition apparatus, tₚₘ represents the time when the other sound source signal in the p^{th} sound source signal combination of the P sound source signal combinations reaches a corresponding sound source acquisition apparatus, and tₚₗ and tₚₘ correspondingly correspond to a tₖ; and

X represents X-coordinate of a sound source corresponding to the sound source signal, Y represents Y-coordinate of the sound source corresponding to the sound source signal, and Z represents Z-coordinate of the sound source corresponding to the sound source signal.

Further, upon step S300, the method further includes the following steps: S700 calculating an average power spectrum intensity of the actual power spectrum of each of the sound source signals to obtain the average power spectrum intensities corresponding to all the sound source signals; S710 ranking the average power spectrum intensities corresponding to all the sound source signals; and S720 estimating direction information of the sound source according to the ranking of the average power spectrum intensities corresponding to all the sound source signals.

Further, upon step S600 and step S720, the method further includes the following steps: S800 determining position information of the sound source according to the estimated direction information and the calculated coordinates; and S810 reporting the position information.

The present disclosure further provides a system for positioning a sound source by a robot. The system includes: several sound source acquisition apparatuses orientated to different directions, configured to respectively acquire sound source signals; a monitoring unit, configured to monitor a plurality of sound source signals acquired by the sound source acquisition apparatuses; a converting unit, configured to, when sound intensities of some sound source signals reach a predetermined sound intensity threshold, convert analog signals of the sound source signals with the sound intensities being greater than the predetermined sound intensity threshold into to-be-processed digital signals corresponding to the sound source signals; a calculating unit, configured to respectively calculate actual power spectrums of the to-be-processed digital signals corresponding to the sound source signals, combine each two sound source signals of the sound source signals to obtain a plurality of sound signal combinations, calculate a delay between two sound source signals in each of the sound source signal combinations, and calculate coordinates of sound sources corresponding to the sound source signals according to the delays between the two sound source signals in the sound source signal combinations, a predetermined sound propagation speed and coordinates of the sound source acquisition apparatuses.

Further, the calculating unit is further configured to respectively calculate spectrums of the sound source signals according to the to-be-processed digital signals corresponding to the sound source signals, and respectively calculate actual power spectrums of the sound source signals according to the spectrums of the sound source signals.

Further, the calculating unit calculates the spectrum of one of the sound source signals using the following formula:

X(n)=a₀*s(n)+a₁*s(n−1)+ . . . +aₙ₋₁*s(n−N−1) (1)

In formula (1), N represents a predetermined sampling point quantity corresponding to one of the sound source signals, s(n) represents a to-be-processed digital signal corresponding to one of the sound source signals corresponding to the n^{th} sampling point, X(n) is a filter signal obtained after FIR filtering is performed for the to-be-processed digital signal corresponding to one of the sound source signals corresponding to the n^{th} sampling point, and a₀-aₙ₋₁ represents n predetermined filter coefficients.

$$\begin{matrix}W ( n ) = \{ \begin{matrix}0.54 - 0.46 cos ( 2 π \frac{n}{N - 1} ) , 0 \leq n \leq ( N - 1 ) \\ 0 , n = else\end{matrix} & ( 2 ) \\ {X}_{N} ( n ) = X ( n ) * W ( n ) & ( 3 )\end{matrix}$$

In formula (2) and formula (3), W(n) represents a window function, X(n) represents a filter signal obtained after FIR filtering is performed for the to-be-processed digital signal corresponding to one of the sound source signals corresponding to the n^{th} sampling point, N represents a predetermined sampling point quality corresponding to one of the sound source signals, X_{N}(n) represents a finite-length filter signal obtained after windowing is performed for the filter signal corresponding to the n^{th} sampling point in one of the sound source signals;

$${X}_{N} ( {e}^{i ω} ) = {\sum }_{n = 0}^{N - 1} {x}_{N} ( n ) {e}^{- i ω n} \qquad ( 4 )$$

In formula (4), X_{N}(n) represents a finite-length filter signal obtained after windowing is performed for the filter signal corresponding to the n^{th} sampling point in one of the sound source signals, and X_{N}(e^{iω}) represents a spectrum corresponding to one of the sound source signals.

The calculating unit calculates the actual power spectrum of one of the sound source signals using the following formula:

$${S}_{x} ( {e}^{i ω} ) = \frac{1}{N} {\vert {X}_{N} ( {e}^{i ω} ) \vert}^{2} \qquad ( 5 )$$

In formula (5), N represents a predetermined sampling point quality corresponding to one of the sound source signals, X_{N}(e^{iω}) represents a spectrum corresponding to one of the sound source signals, and Sₓ(e^{iω}) represents an actual power spectrum corresponding to one of the sound source signals.

Further, the calculating unit is further configured to calculate a mutual power spectrum between the two sound source signals in each of the sound source signal combinations according to actual power spectrums of the two sound source signals in the sound source signal combinations, calculate a frame cross-correlation function between the two sound source signals in each of the sound source signal combinations according to the mutual power spectrums of the sound source signal combinations, and calculate a delay between the two sound source signals in each of the sound source signal combinations according to the frame cross-correlation functions between the two sound source signals in the sound source signal combinations.

Further, the calculating unit calculates the mutual power spectrum between the two sound source signals in each of the sound source signal combinations using the following formula:

$${G}_{lm} ( ω ) = {X}_{l} ( ω ) {X}_{m}^{*} ( ω ) = {abG}_{ss} ( ω ) {e}^{- j ω ( {τ}_{l} - {τ}_{m} )} + {G}_{{n}_{l} {n}_{{ }_{m}}} ( ω ) ; \qquad ( 6 )$$

In formula (6), Xₗ(ω) represents an actual power spectrum of one sound source signal in one of the sound source signal combination, Xₘ*(ω) represents an actual power spectrum of another sound source signal in the sound source signal combinations, Gₗₘ(ω) represents a mutual power spectrum between two sound source signals in the sound source signal combination, Gₛₛ(ω)e^{-jω(τ}^{ₗ}^{-τ}^{ₘ}⁾ represents a power spectrum between two sound source signals in the sound source signal combination,

$${G}_{{n}_{l} {n}_{{ }_{m}}} ( ω )$$

represents a mutual spectrum of an additive noise signal of two sound source signals in the sound source signal combination, and a and b are predetermined constants.

Further, the calculating unit calculates the frame cross-correlation function the two sound source signals in each of the sound source signal combinations using the following formula:

$${R}_{lm}^{g} ( τ ) = {\int }_{∞}^{∞} φ ( ω ) {G}_{lm} ( ω ) {e}^{j ωτ} d ω \qquad ( 7 )$$

In formula (7), φ(ω) represents a weighting function, Rₗₘ^{g}(τ) represents a frame cross-correlation function between two sound source signals of one of the sound source signal combinations, and Gₗₘ(ω) represents a mutual power spectrum between two sound source signals of the sound source signal combination.

Further, the calculating unit calculates the delay between the two sound source signals in each of the sound source signal combinations using the following formula:

φ(ω)=1/|Gₗₘ(ω)| (8)

In formula (8), Gₗₘ(ω) represents a mutual power spectrum between two sound source signals in each of the sound source signal combinations;

According to the φ(ω) weighting function, the frame cross-correlation function of each of the sound source signal combinations is:

$${R}_{lm}^{g} ( τ ) = {\int }_{∞}^{∞} \frac{{G}_{lm} ( ω )}{\vert {G}_{lm} ( ω ) \vert} {e}^{j ωτ} d ω = ab δ ( τ - ( {τ}_{l} - {τ}_{m} ) ) \qquad ( 9 )$$

In formula (9), a and b are predetermined constants, δ(τ−(τₗ−τₘ)) represents a delay function between two sound source signals in each of the sound source signal combinations, τ represents a delay between two sound source signals in each of the sound source signal combinations, τₗ represents the time when one sound source signal in the sound source signal combination reaches a corresponding sound source acquisition apparatus, τₘ represents the time when the other sound source signal in the sound source signal combination reaches a corresponding sound source acquisition apparatus, and when the frame cross-correlation function takes a peak value, τ=τₗ−τₘ.

Further, the calculating unit calculates the coordinates of the sound sources corresponding to the sound source signals using the following formulae:

(Xₖ−X)²+(Yₖ−Y)²+(Zₖ−Z)²=Ctₖ² (10);

τₚ=tₚₗ−tₚₘ (11);

wherein K sound source acquisition apparatus are configured, Xₖ represents X-coordinate of the k^{th} sound source acquisition apparatus of all the sound source acquisition apparatuses, Yₖ represents Y-coordinate of the k^{th} sound source acquisition apparatus of all the sound source acquisition apparatuses, Zₖ represents Z-coordinate of the k^{th} sound source acquisition apparatus of all the sound source acquisition apparatuses, k is a natural number and is not greater than the total number of sound source acquisition apparatuses, tₖ represents the time when the k^{th} sound source signal reaches a corresponding sound source acquisition apparatus;

C represents a predetermined sound propagation speed;

each two sound source signals of K sound source signals corresponding to the K sound source acquisition apparatuses are combined to obtain P sound source signal combinations, τₚ represents a delay between two sound source signals in the p^{th} sound source signal combination of the P sound source signal combinations, tₚₗ represents the time when one sound source signal in the p^{th} sound source signal combination of the P sound source signal combinations reaches a corresponding sound source acquisition apparatus, tₚₘ represents the time when the other sound source signal in the p^{th} sound source signal combination of the P sound source signal combinations reaches a corresponding sound source acquisition apparatus, and tₚₗ and tₚₘ correspondingly correspond to a tₖ; and

X represents X-coordinate of a sound source corresponding to the sound source signal, Y represents Y-coordinate of the sound source corresponding to the sound source signal, and Z represents Z-coordinate of the sound source corresponding to the sound source signal.

Further, the calculating unit is further configured to calculate an average power spectrum intensity of the actual power spectrum of each of the sound source signals to obtain the average power spectrum intensities corresponding to all the sound source signals. The system further includes: calculate an average power spectrum intensity of the actual power spectrum of each of the sound source signals to obtain the average power spectrum intensities corresponding to all the sound source signals; and an estimating unit, configured to estimate direction information of the sound source according to the ranking of the average power spectrum intensities corresponding to all the sound source signals.

Further, the system further includes: a reporting unit, configured to determine position information of the sound source according to the estimated direction information and the calculated coordinates, and report the position information.

Further, four sound source acquisition apparatuses are used.

The number of sound source acquisition apparatuses may be four, or may be eight or the like.

As seen from the above technical solutions, the approximate direction of the sound source is estimated with reference to the spatial direction of the sound source signals and the average power spectrum intensities of the sound source signals. Since the speaker array is generally arranged on the head of the robot, the sound source positioning calculation result is sent to a head expression control board via a serial port. The expression control board sends the sound source positioning result to the robot man-machine interaction apparatus, for example, a PAD board, such that the robot makes a decision and performs a corresponding operation.

In the method for positioning a sound source by a robot according to the present disclosure, with a combination of delay estimation and power spectrum intensity, the approximate direction of the sound source is estimated according to the power spectrum intensities received by the sound source acquisition apparatuses and the spatial directions of the sound source acquisition apparatuses. As such, the approximate direction of the sound source may be accurately estimated. The power spectrum intensity comparison refers to calculating an average power spectrum intensity of the sound source acquisition apparatuses within a specific frequency interval, and the average power spectrum intensity is inversely proportion to the distance from the sound source to the sound source acquisition apparatuses. A point with a greater average power spectrum intensity is proximal to the sound source acquisition apparatus, and a point with a smaller average power spectrum intensity is distal from the sound source acquisition apparatus.

The method and system for positioning a sound source by a robot according to the present disclosure are capable of relatively correctly position a sound source in the vicinity of the robot. This provides a direction basis for further actions, and improves intelligence of robot man-machine interaction.

### BRIEF DESCRIPTION OF THE DRAWINGS

FIG. 1 is a flowchart of a generalized delay estimation algorithm according to the present disclosure;

FIG. 2 is a principle diagram of delay signal generation;

FIG. 3 is a principle of determining a spatial direction according to a delay signal;

FIG. 4 is a waveform of a mutual power spectrum signal;

FIG. 5 is a principle diagram of a sampling circuit in a sound source acquisition apparatus;

FIG. 6 is a circuit principle diagram of a sound source positioning and calculating unit;

FIG. 7 is a modular diagram of a system for positioning a sound source by a robot;

FIG. 8 is a flowchart of a method for positioning a sound source by a robot according to the present disclosure;

FIG. 9 is a schematic diagram illustrating directions of four microphones according to an embodiment of the present disclosure;

FIG. 10 is a schematic diagram illustrating the position of a sound source positioning module on the robot according to an embodiment of the present disclosure;

FIG. 11 is a flowchart of a method for positioning a sound source by a robot according to one embodiment of the present disclosure;

FIG. 12 is a flowchart of a method for positioning a sound source by a robot according to another embodiment of the present disclosure;

FIG. 13 is a flowchart of a method for positioning a sound source by a robot according to another embodiment of the present disclosure;

FIG. 14 is a schematic structural diagram of a system for positioning a sound source by a robot according to one embodiment of the present disclosure; and

FIG. 15 is a schematic structural diagram of a system for positioning a sound source by a robot according to another embodiment of the present disclosure.

### DETAILED DESCRIPTION

Hereinafter a method and system for positioning a sound source by a robot according to the present disclosure are described in retail with reference to the accompanying drawings.

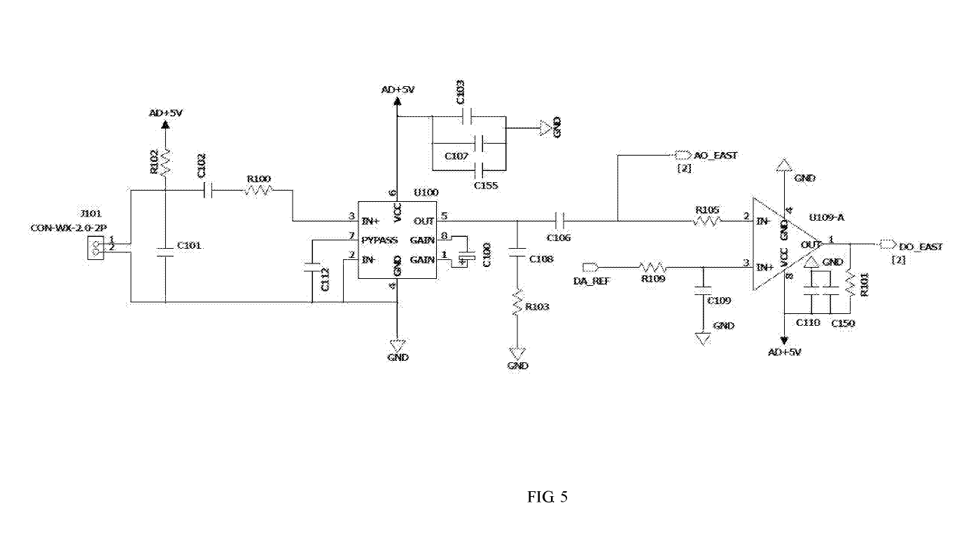

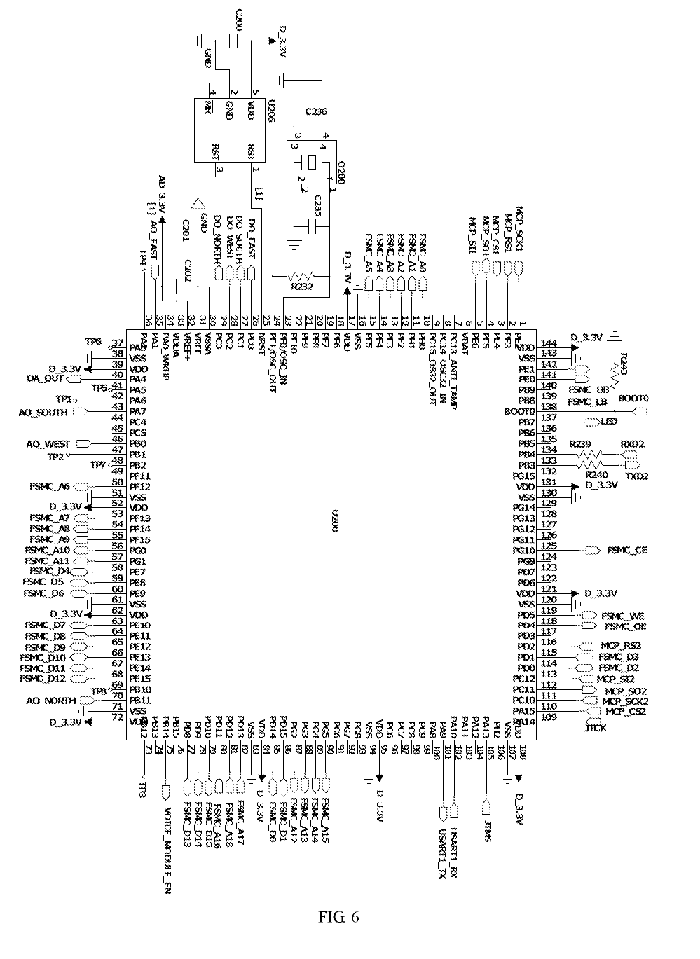

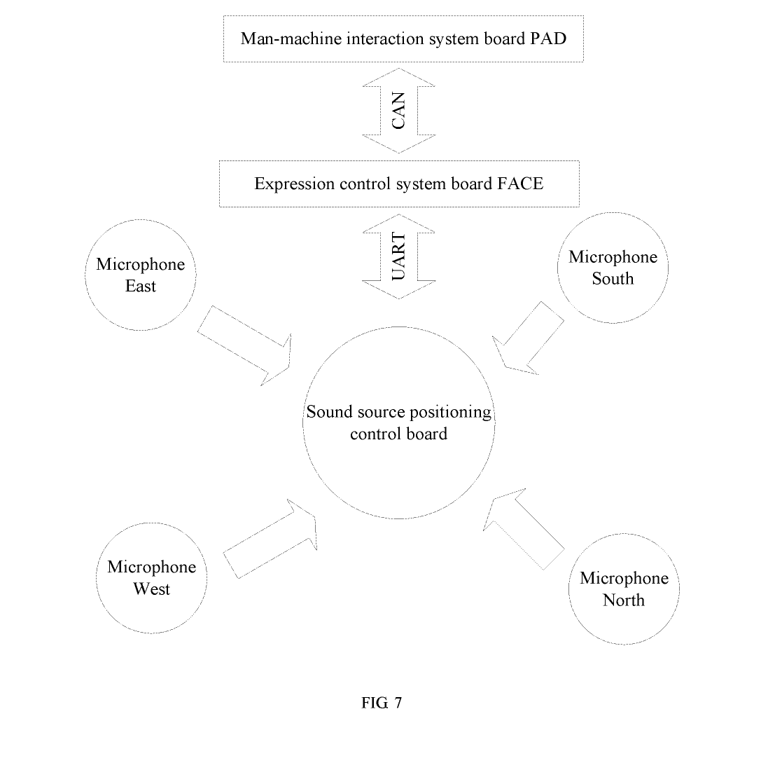

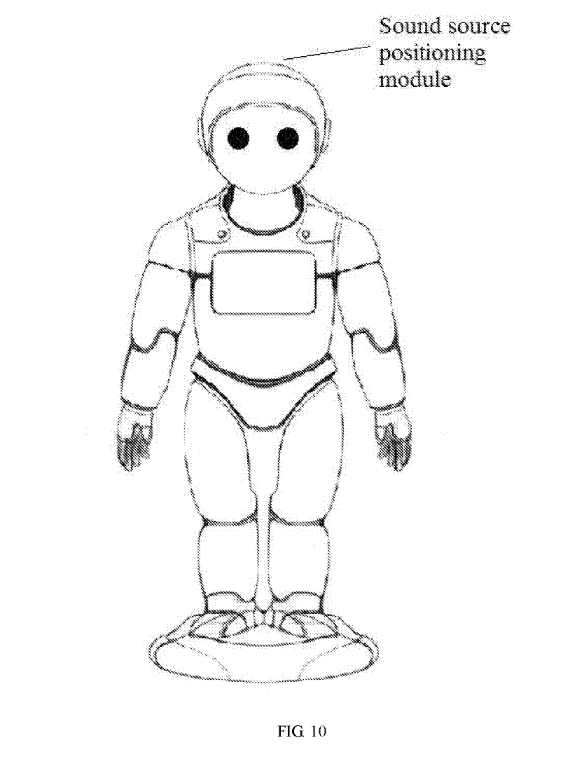

As illustrated in FIG. 7 and FIG. 10, the system for positioning a sound source by a robot according to the present disclosure may be generally applied to robots having a sound source positioning module, and may also be applied to other robots. The sound source positioning module may be located at the head of the robot, or may be located at other parts, especially for a non-hominine robot. The sound source positioning module has a sound source control board, which may control sound acquisition apparatuses, wherein the sound source acquisition apparatus is generally a microphone. The sound source control board is connected to a facial expression control system board and a man-machine interaction system board. FIG. 5 is a principle diagram of a sampling circuit of the sound source acquisition apparatus, and FIG. 6 is a circuit principle diagram of a sound source positioning operation unit.

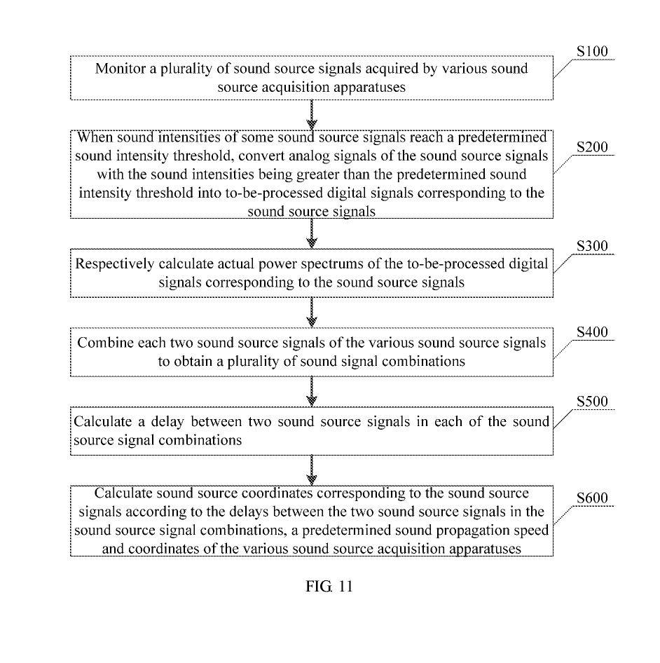

In another embodiment of the present disclosure, as illustrated in FIG. 11, a method for positioning a sound source by a robot includes the following steps:

S100: A plurality of sound source signals acquired by various sound source acquisition apparatuses are monitored.

The sound source acquisition apparatus may be a microphone, which may acquire sound source signals sent by a sound source in an ambient environment. Each microphone may acquire an analog signal of one sound source signal according to a predetermined sampling point quantity.

S200: When sound intensities of some sound source signals reach a predetermined sound intensity threshold, analog signals of the sound source signals with the sound intensities being greater than the predetermined sound intensity threshold are converted into to-be-processed digital signals corresponding to the sound source signals.

The sound source signals may be further processed only when the intensities of the sound source signal reach a predetermined sound intensity threshold. Firstly, analog signals of the sound source signals need to be converted into the corresponding to-be-processed digital signals for subsequent calculations.

S300: Actual power spectrums of the to-be-processed digital signals corresponding to the sound source signals are respectively calculated.

Calculation of the actual power spectrum provides a basis for calculation of coordinates of the sound source.

S400: Each two sound source signals of the various sound source signals are combined to obtain a plurality of sound signal combinations.

Assume that four sound source acquisition apparatuses are configured, four sound source signals are present; in this case, based on a combination of each two sound source signals, six sound source signal combinations may be obtained, namely, AB, AC, AD, BC, BD and CD.

S500: A delay between two sound source signals in each of the sound source signal combinations is calculated.

If there are six sound source signal combinations, six delays may be obtained via calculation.

S600: Sound source coordinates corresponding to the sound source signals are calculated according to the delays between the two sound source signals in the sound source signal combinations, a predetermined sound propagation speed and coordinates of the various sound source acquisition apparatuses.

In this embodiment, the predetermined sound propagation speed is a propagation speed of sound waves in the medium air, and may be predefined in the robot; whereas the positions where the sound source acquisition apparatuses in the robot are fixed. Therefore, the coordinates of the sound source acquisition apparatuses are known, which may also be predefined in the robot. As such, more accurate coordinates of the sound source may be calculated according to the above disclosure.

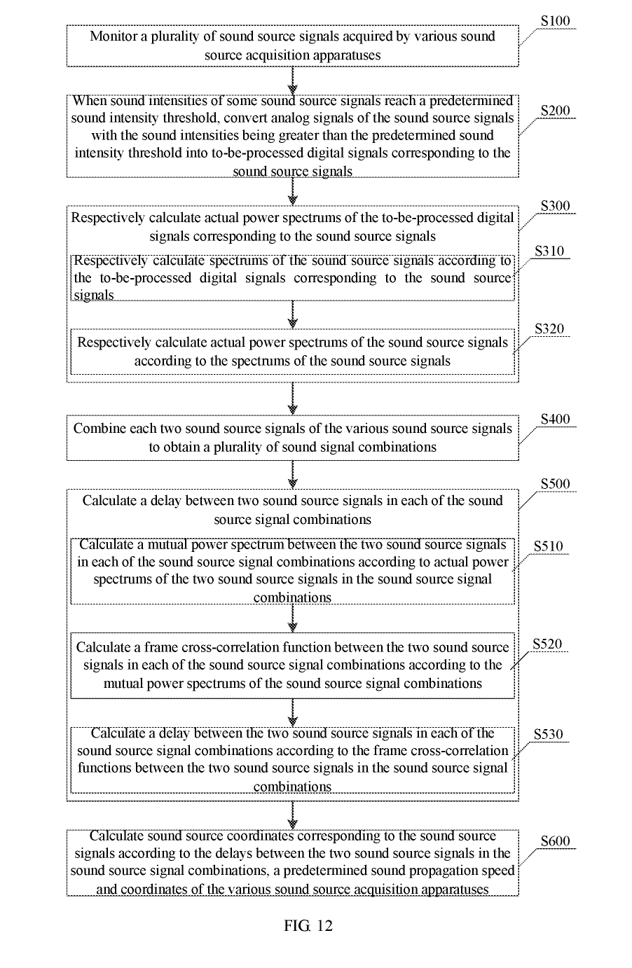

In another embodiment of the present disclosure, based on the above embodiment, as illustrated in FIG. 12, step S300 includes the following steps:

S310: Spectrums of the sound source signals are respectively calculated according to the to-be-processed digital signals corresponding to the sound source signals.

S320: Actual power spectrums of the sound source signals are respectively calculated according to the spectrums of the sound source signals.

Preferably, in step S310, the spectrum of one of the sound source signals is calculated using the following formula:

X(n)=a₀*s(n)+a₁*s(n−1)+ . . . +aₙ₋₁*s(n−N−1) (1)

In formula (1), N represents a predetermined sampling point quantity corresponding to one of the sound source signals, s(n) represents a to-be-processed digital signal corresponding to one of the sound source signals corresponding to the n^{th} sampling point, X(n) is a filter signal obtained after FIR filtering is performed for the to-be-processed digital signal corresponding to one of the sound source signals corresponding to the n^{th} sampling point, and a₀-aₙ₋₁ represents n predetermined filter coefficients;

$$\begin{matrix}W ( n ) = \{ \begin{matrix}0.54 - 0.46 cos ( 2 π \frac{n}{N - 1} ) , 0 \leq n \leq ( N - 1 ) \\ 0 , n = else\end{matrix} & ( 2 ) \\ {X}_{N} ( n ) = X ( n ) * W ( n ) & ( 3 )\end{matrix}$$

In formula (2) and formula (3), W(n) represents a window function, X(n) represents a filter signal obtained after FIR filtering is performed for the to-be-processed digital signal corresponding to one of the sound source signals corresponding to the n^{th} sampling point, N represents a predetermined sampling point quality corresponding to one of the sound source signals, X_{N}(n) represents a finite-length filter signal obtained after windowing is performed for the filter signal corresponding to the n^{th} sampling point in one of the sound source signals;

$${X}_{N} ( {e}^{i ω} ) = {\sum }_{n = 0}^{N - 1} {x}_{N} ( n ) {e}^{- i ω n} \qquad ( 4 )$$

In formula (4), X_{N}(n) represents a finite-length filter signal obtained after windowing is performed for the filter signal corresponding to the n^{th} sampling point in one of the sound source signals, and X_{N}(e^{iω}) represents a spectrum corresponding to one of the sound source signals.

Specifically, the spectrum of one sound source signal may be calculated using formula (1) to formula (4); and if there are a plurality of sound source signals, multiple calculations may be cyclically performed until the spectrums of all the sound source signals are obtained.

In step S320, the actual power spectrum of one of the sound source signals is calculated using the following formula:

$${S}_{x} ( {e}^{i ω} ) = \frac{1}{N} {\vert {X}_{N} ( {e}^{i ω} ) \vert}^{2} \qquad ( 5 )$$

In formula (5), N represents a predetermined sampling point quality corresponding to one of the sound source signals, X_{N}(e^{iω}) represents a spectrum corresponding to one of the sound source signals, and Sₓ(e^{iω}) represents an actual power spectrum corresponding to one of the sound source signals.

Specifically, the actual power spectrum of one sound source signal may be calculated using formula (5); and if there are a plurality of sound source signals, multiple calculations may be cyclically performed until the actual power spectrums of all the sound source signals are obtained.

In another embodiment of the present disclosure, based on the above embodiment, as illustrated in FIG. 12, step S500 includes the following steps:

S510: A mutual power spectrum between the two sound source signals in each of the sound source signal combinations is calculated according to actual power spectrums of the two sound source signals in the sound source signal combinations.

S520: A frame cross-correlation function between the two sound source signals in each of the sound source signal combinations is calculated according to the mutual power spectrums of the sound source signal combinations.

S530: A delay between the two sound source signals in each of the sound source signal combinations is calculated according to the frame cross-correlation functions between the two sound source signals in the sound source signal combinations.

Preferably, in step S510, the mutual power spectrum between the two sound source signals in each of the sound source signal combinations is calculated using the following formula:

$${G}_{lm} ( ω ) = {X}_{l} ( ω ) {X}_{m}^{*} ( ω ) = {abG}_{ss} ( ω ) {e}^{- j ω ( {τ}_{l} - {τ}_{m} )} + {G}_{{n}_{l} {n}_{{ }_{m}}} ( ω ) ; \qquad ( 6 )$$

In formula (6), Xₗ(ω) represents an actual power spectrum of one sound source signal in one of the sound source signal combination, Xₘ*(ω) represents an actual power spectrum of another sound source signal in the sound source signal combinations, Gₗₘ(ω) represents a mutual power spectrum between two sound source signals in the sound source signal combination, Gₛₛ (ω)e^{-jω(τ}^{ₗ}^{-τ}^{ₘ}⁾ represents a power spectrum between two sound source signals in the sound source signal combination,

$${G}_{{n}_{l} {n}_{{ }_{m}}} ( ω )$$

represents a mutual spectrum of an additive noise signal of two sound source signals in the sound source signal combination, and a and b are predetermined constants (which may be defined empirically).

Specifically, one sound source signal combination has two sound source signals, and a mutual spectrum between these two sound source signals is calculated using formula (6). Since there are a plurality of sound source signal combinations, the mutual spectrum between each two sound source signals in the sound source signal combinations may be calculated cyclically using this formula.

After the mutual spectrums of the sound source signal combinations are obtained, frequency-domain weighting calculation may be performed for the mutual spectrum of each of the sound source signal combinations to obtain frequency-domain weighted calculation values of the sound source signal combinations. Afterwards, inverse fast Fourier transformation is performed for each of the frequency-domain weight calculation values of the sound source signal combinations to obtain frame cross-correlation functions of the sound source signal combinations.

Preferably, in step S520, the frame cross-correlation function the two sound source signals in each of the sound source signal combinations is calculated using the following formula:

$${R}_{lm}^{g} ( τ ) = {\int }_{∞}^{∞} φ ( ω ) {G}_{lm} ( ω ) {e}^{j ωτ} d ω \qquad ( 7 )$$

In formula (7), φ(ω) represents a weighting function, Rₗₘ^{g}(τ) represents a frame cross-correlation function between two sound source signals of one of the sound source signal combinations, and Gₗₘ(ω) represents a mutual power spectrum between two sound source signals of the sound source signal combination.

Specifically, the frame cross-correlation function between two sound source signals in each of the sound source signal combinations is calculated to obtain a delay between the two sound source signals in the same sound source signal combination. Therefore, the weighting function may employ the following formula:

φ(ω)=1/|Gₗₘ(ω)| (8)

In formula (8), Gₗₘ(ω) represents a mutual power spectrum between two sound source signals in each of the sound source signal combinations.

according to the φ(ω) weighting function, the frame cross-correlation function of each of the sound source signal combinations is:

$${R}_{lm}^{g} ( τ ) = {\int }_{∞}^{∞} \frac{{G}_{lm} ( ω )}{\vert {G}_{lm} ( ω ) \vert} {e}^{j ωτ} d ω = ab δ ( τ - ( {τ}_{l} - {τ}_{m} ) ) \qquad ( 9 )$$

In formula (9), a and b are predetermined constants, δ(τ−(τₗ−τₘ)) represents a delay function between two sound source signals in each of the sound source signal combinations, τ represents a delay between two sound source signals in each of the sound source signal combinations, τₗ represents the time when one sound source signal in the sound source signal combination reaches a corresponding sound source acquisition apparatus, τₘ represents the time when the other sound source signal in the sound source signal combination reaches a corresponding sound source acquisition apparatus, and when the frame cross-correlation function takes a peak value, τ=τ₁−τₘ.

In another embodiment of the present disclosure, based on the above embodiment, the coordinates of the sound source corresponding to the sound source signal in step S600 are calculated using the following formulae:

(Xₖ−X)²+(Yₖ−Y)²+(Zₖ−Z)²=Ctₖ² (10)

τₚ=tₚₗ−tₚₘ (11)

wherein K sound source acquisition apparatus are configured, Xₖ represents X-coordinate of the k^{th} sound source acquisition apparatus of all the sound source acquisition apparatuses, Yₖ represents Y-coordinate of the k^{th} sound source acquisition apparatus of all the sound source acquisition apparatuses, Zₖ represents Z-coordinate of the k^{th} sound source acquisition apparatus of all the sound source acquisition apparatuses, k is a natural number and is not greater than the total number of sound source acquisition apparatuses, tₖ represents the time when the k^{th} sound source signal reaches a corresponding sound source acquisition apparatus;

C represents a predetermined sound propagation speed;

each two sound source signals of K sound source signals corresponding to the K sound source acquisition apparatuses are combined to obtain P sound source signal combinations, τₚ represents a delay between two sound source signals in the p^{th} sound source signal combination of the P sound source signal combinations, tₚₗ represents the time when one sound source signal in the p^{th} sound source signal combination of the P sound source signal combinations reaches a corresponding sound source acquisition apparatus, tₚₘ represents the time when the other sound source signal in the p^{th} sound source signal combination of the P sound source signal combinations reaches a corresponding sound source acquisition apparatus, and tₚₗ and tₚₘ correspondingly correspond to a tₖ; and

X represents X-coordinate of a sound source corresponding to the sound source signal, Y represents Y-coordinate of the sound source corresponding to the sound source signal, and Z represents Z-coordinate of the sound source corresponding to the sound source signal.

Specifically, assume that there are four sound source acquisition apparatuses, then K=4, and formula (10) may be transformed into:

$$\{ \begin{matrix}{( {X}_{1} - X )}^{2} + {( {Y}_{1} - Y )}^{2} + {( {Z}_{1} - Z )}^{2} = {Ct}_{1}^{2} \\ {( {X}_{2} - X )}^{2} + {( {Y}_{2} - Y )}^{2} + {( {Z}_{2} - Z )}^{2} = {Ct}_{2}^{2} \\ {( {X}_{3} - X )}^{2} + {( {Y}_{3} - Y )}^{2} + {( {Z}_{3} - Z )}^{2} = {Ct}_{3}^{2} \\ {( {X}_{4} - X )}^{2} + {( {Y}_{4} - Y )}^{2} + {( {Z}_{4} - Z )}^{2} = {Ct}_{4}^{2}\end{matrix} \qquad ( 12 )$$

Each two sound source signals of four sound source signals corresponding to the four sound source acquisition apparatuses to obtain six sound signal combinations. That is, a delay of the combination of the first sound source signal and the second sound source signal is τ₁=τ₁₂, a delay of the combination of the first sound source signal and the third sound signal is τ₂=τ₁₃, a delay of the combination of the first sound source signal and the fourth sound source signal is τ₃=τ₁₄, a delay of the combination of the second sound source signal and the third sound source signal is τ₄=τ₂₄, a delay of the combination of the second sound source signal and the fourth sound source signal is τ₅=τ₂₄, and a delay of the combination of the third sound source signal and the fourth sound source signal is τ₆=τ₃₄.

That is, formula (11) may be transformed into:

$$\{ \begin{matrix}{τ}_{1} = {t}_{1 l} - {t}_{1 m} \\ {τ}_{2} = {t}_{2 l} - {t}_{2 m} \\ {τ}_{3} = {t}_{3 l} - {t}_{3 m} \\ {τ}_{4} = {t}_{4 l} - {t}_{4 m} \\ {τ}_{5} = {t}_{5 l} - {t}_{5 m} \\ {τ}_{6} = {t}_{6 l} - {t}_{6 m}\end{matrix} \qquad ( 13 )$$

Since each sound source signal is each sound source signal combination has its corresponding tₖ, formula (13) may be further transformed into:

$$\{ \begin{matrix}{τ}_{12} = {t}_{1} - {t}_{2 } \\ {τ}_{13} = {t}_{1} - {t}_{3} \\ {τ}_{14} = {t}_{1} - {t}_{4} \\ {τ}_{23} = {t}_{2} - {t}_{3} \\ {τ}_{24} = {t}_{2} - {t}_{4} \\ {τ}_{34} = {t}_{3} - {t}_{4}\end{matrix} \qquad ( 14 )$$

The delay of two sound source signals in each sound source signal combination is obtained by taking a peak value of the frame cross-correlation function. From the above formula, time t₁, t₂, t₃ and t₄ of the sound source acquisition apparatuses corresponding to the sound source signals may be obtained. The coordinates of the sound source may be calculated by substituting the calculated t₁, t₂, t₃ and t₄ into formula (12).

In this embodiment, the coordinates of the sound source may be determined by using the above method, and the coordinates may be directly reported.

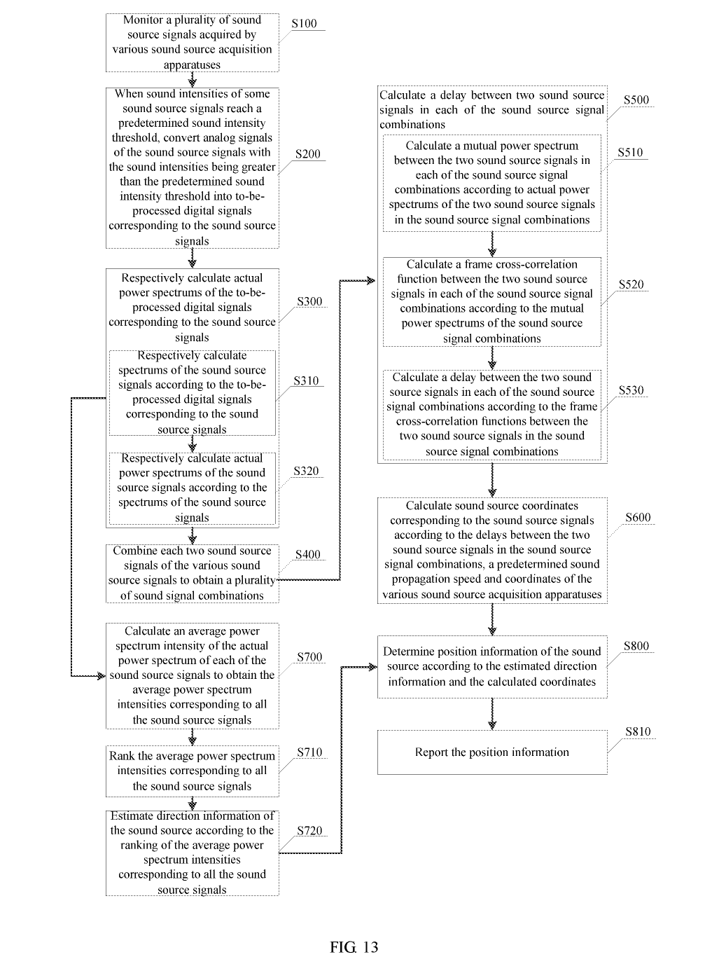

In another embodiment of the present disclosure, based on the above embodiment, as illustrated in FIG. 13, upon step S300, the method further includes the following steps:

S700: An average power spectrum intensity of the actual power spectrum of each of the sound source signals is calculated to obtain the average power spectrum intensities corresponding to all the sound source signals.

S710: The average power spectrum intensities corresponding to all the sound source signals are ranked.

S720: Direction information of the sound source is estimated according to the ranking of the average power spectrum intensities corresponding to all the sound source signals.

Specifically, after the actual power spectrums of the sound source signals are calculated, an average power spectrum intensity corresponding to each sound source signal may be calculated according to the actual power spectrums, such that the sound source signals are ranked according to the average power spectrum intensities thereof to estimate the direction information of the sound source.

For example, there are four microphones orientated to the east, south, west and north, and the average power spectrum intensities thereof are ranked as follows: east, west, south and north. Based on such ranking, it is estimated that the direction information is the east. If a difference between the average power spectrum intensity corresponding to the sound source signal in the east and the average power spectrum intensity corresponding to the sound source signal in the west is within a predetermined range, it is considered that the direction information is the east and west.

In this embodiment, the direction of the sound source may be further positioned according to the average power spectrum intensity.

Preferably, upon step S600 and step S720, the method further includes the following steps: S800 determining position information of the sound source according to the estimated direction information and the calculated coordinates; and S810 reporting the position information to a head expression control board.

Specifically, after the coordinates are calculated and the direction information is estimated, the coordinates and the direction information may be reported as position information. Due to connection to the head expression control board, the position information may be reported to the head expression information, such that the robot performs subsequent actions.

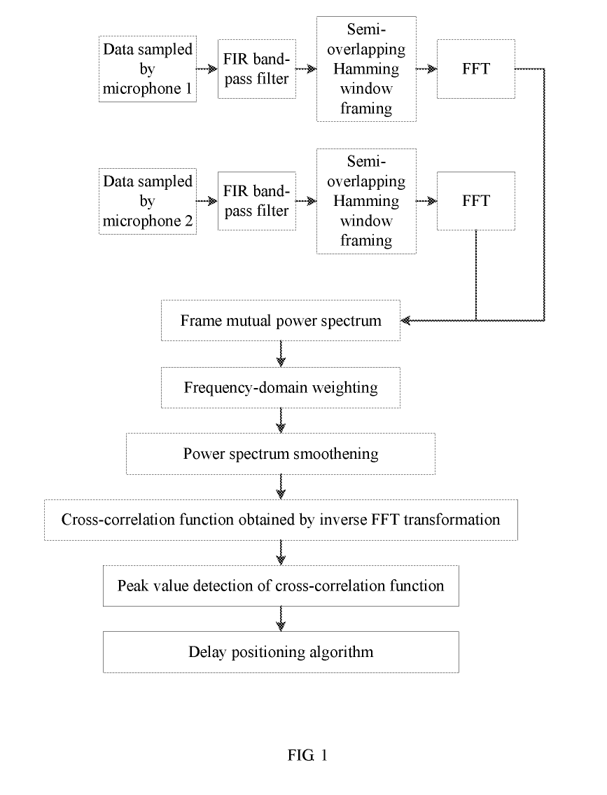

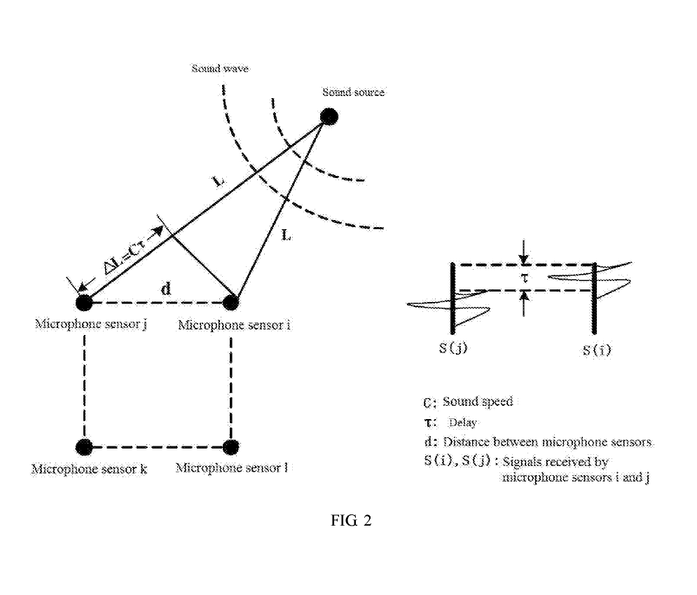

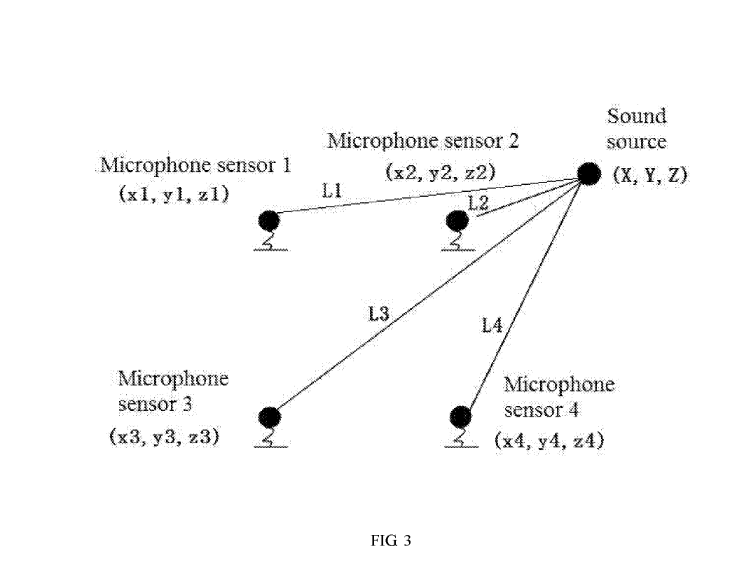

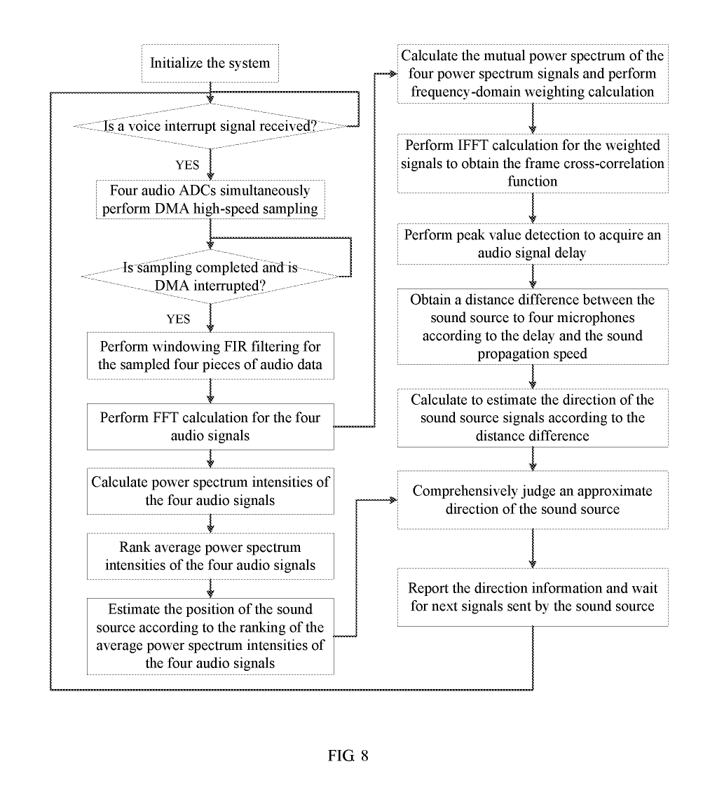

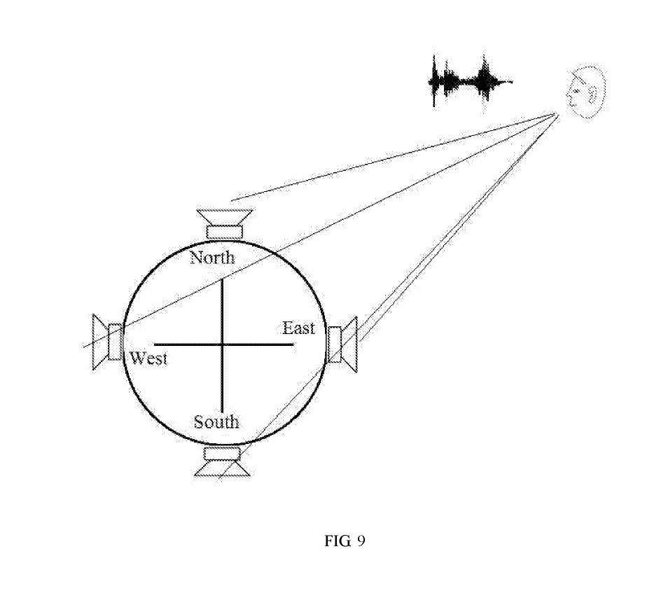

As illustrated in FIG. 1, FIG. 2, FIG. 3, FIG. 8 and FIG. 9, the method for positioning a sound source by a robot according to the present disclosure includes the following steps:

1) Several sound source acquisition apparatuses orientated to different directions are arranged on the robot, and a sound intensity threshold is defined. The number of sound source acquisition apparatuses is not limited. In this embodiment, using four microphones as an example, the distances between the four microphones and the sound source are different.

2) If the sound intensity reaches the predetermined sound intensity threshold, the sound source acquisition apparatus outputs several analog signals, and converts the analog signals into to-be-processed digital signals.

3) A Fourier transformation is performed for the to-be-processed digital signals.

A finite-length filter signal X_{N}(n) is obtained by data windowing, and a Fourier transformation is directly performed for the filter signal to obtain spectrum X_{N}(e^{iω}).

$${X}_{N} ( {e}^{i ω} ) = {\sum }_{n = 0}^{N - 1} {x}_{N} ( n ) {e}^{- i ω n}$$

The spectrum amplitude is squared, and the square is divided by N, based on which the actual power spectrum Sₓ(e^{iω}) of x(n) is estimated:

$${S}_{x} ( {e}^{i ω} ) = \frac{1}{N} {\vert {X}_{N} ( {e}^{i ω} ) \vert}^{2}$$

4) An average power spectrum intensity of the to-be-processed digital signal is calculated.

5) The average power spectrum intensities of the sound source signals are ranked.

6) The position of the sound source is estimated according to the ranking of the average power spectrum intensities of the sound source signals.

Since the microphone array is arranged on the head of the robot, the calculation result of sound source positioning may be sent to a head expression control board via a serial port. The expression control board sends the sound source positioning result to the robot man-machine interaction apparatus, for example, a PAD board, such that the robot makes a decision and performs a corresponding operation. The signaling flowchart is as illustrated in FIG. 7, and the software calculation process of the sound source positioning system is as illustrated in FIG. 8. As illustrated in FIG. 10, the sound source positioning module is arranged on the head of the robot, and the four microphones form a rectangular and four corners of the rectangular are tightly attached under the skull of the robot.

For more accurate calculation of the sound source, the steps upon step 3) may be substituted by the following process:

41) The mutual power spectrum of the sound source signal experiencing the fast Fourier transformation is calculated. Assume that Xₗ(ω) and Xₘ*(ω) are signals received by two microphones, then the signals Xₗ(ω) and Xₘ*(ω) are prefiltered and subjected to a Fourier transformation to obtain the mutual spectrum Gₗₘ (ω) therebetween:

$${G}_{lm} ( ω ) = {X}_{l} ( ω ) {X}_{m}^{*} ( ω ) = {abG}_{ss} ( ω ) {e}^{- j ω ( {τ}_{l} - {τ}_{m} )} + {G}_{{n}_{l} {n}_{{ }_{m}}} ( ω )$$

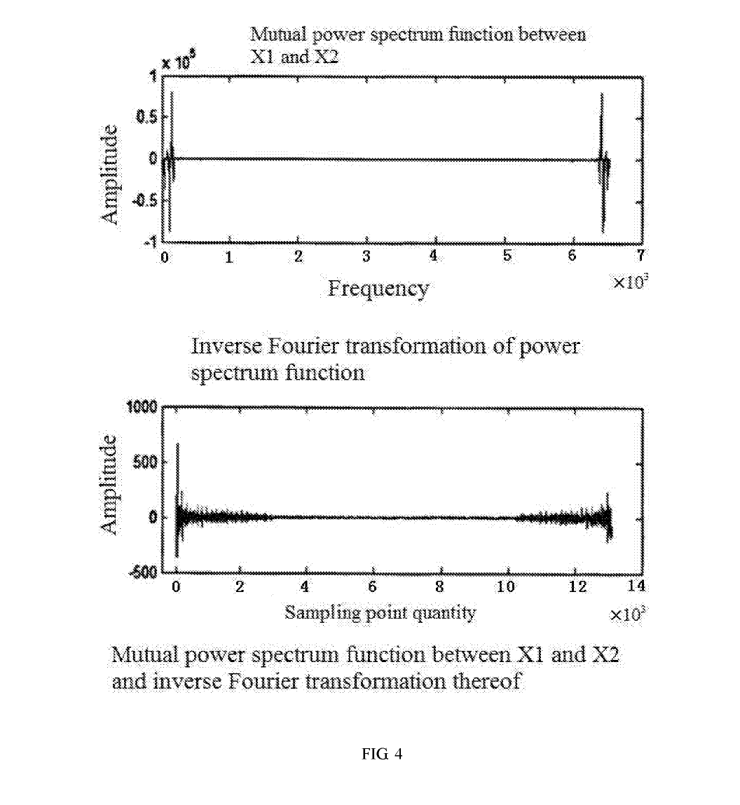

The calculation result is as illustrated in FIG. 4.

As illustrated in FIG. 4, 51) frequency-domain weighting calculation is performed for the mutual spectrums of the sound source signals; and an inverse fast Fourier transformation is performed for the signal upon the weighting calculation to obtain the frame cross-correlation function:

$${R}_{lm}^{g} ( τ ) = {\int }_{∞}^{∞} φ ( ω ) {G}_{lm} ( ω ) {e}^{j ω τ} d ω$$

In the formula, φ(ω) denotes a weighting function, wherein to obtain a great peak value of the cross-correlation function, the input signals need to be normalized, and the following weighting function is selected:

φ(ω)=1/|Gₗₘ(ω)|

Therefore, in an ideal model, the cross-correlation function may be expressed as follows:

$${R}_{lm}^{g} ( τ ) = {\int }_{∞}^{∞} \frac{{G}_{lm} ( ω )}{\vert {G}_{lm} ( ω ) \vert} {e}^{j ωτ} d ω = ab δ ( τ - ( {τ}_{l} - {τ}_{m} ) )$$

The peak value of Rₗₘ^{g}(τ) is obtained when τ=τₗ−τₘ, that is, the delay between two signals; a distance between the sound source and two sensors is ΔL=C*τ, and therefore, as regards the time when the signals of the sound wave emitted by the sound source reaches two sensors, τ=ΔL/C.

Using FIG. 2 as an example, τ denotes a delay between microphone sensor j and microphone sensor i, signal Sᵢ is later than signal Sⱼ by time τ; that is, in an ideal condition where noise is ignored, the signals received by sensors i and j satisfy the equation Sᵢ=Sⱼ(t−τ), that is, a time delay is present between the two signals.

61) The peak value is detected to acquire a delay of the sound source signals.

71) A distance difference between two sound source acquisition apparatuses is calculated according to the delay of the sound source signals and a propagation speed (that is, a predetermined sound propagation speed C) of the sound in the room temperature; the spatial coordinates of the sound source acquisition apparatuses are known as (Xᵢ, Yᵢ, Zᵢ), wherein (i=1, 2, . . . K), K denotes the total number of elements (that is, the total number of sound source acquisition apparatuses), the spatial coordinates of the sound source is (X, Y, Z), and the following e equations may be obtained through space analytic geometry:

$$\{ \begin{matrix}{( {x}_{1} - x )}^{2} + & {( {y}_{1} - y )}^{2} + & {( {z}_{1} - z )}^{2} = & {Ct}_{1}^{2} \\ {( {x}_{2} - x )}^{2} + & {( {y}_{2} - y )}^{2} + & {( {z}_{2} - z )}^{2} = & {Ct}_{2}^{2} \\ {( {x}_{3} - x )}^{2} + & {( {y}_{3} - y )}^{2} + & {( {z}_{3} - z )}^{2} = & {Ct}_{3}^{2} \\ {( {x}_{4} - x )}^{2} + & {( {y}_{4} - y )}^{2} + & {( {z}_{4} - z )}^{2} = & {Ct}_{4}^{2} \\ ⋮ & ⋮ & ⋮ & ⋮\end{matrix}$$

C denotes a sound speed (a predetermined sound propagation speed), tᵢ denotes time when the sound wave reaches the sound source acquisition apparatuses, and the following equations may be determined according to delay estimation and calculation:

$$\{ \begin{matrix}{τ}_{21} = & {t}_{2} - & {t}_{1 } \\ {τ}_{31} = & {t}_{3} - & {t}_{1} \\ {τ}_{41} = & {t}_{4} - & {t}_{1} \\ ⋮ & ⋮ & ⋮\end{matrix}$$

The above equations are solved to obtain the spatial coordinates (X, Y, Z) of the sound source, that is, the spatial position of the sound source is obtained.

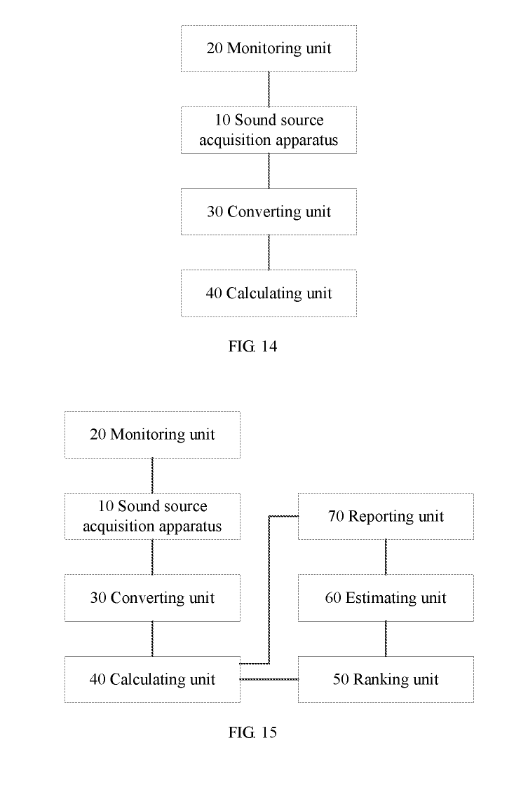

In another embodiment of the present disclosure, as illustrated in FIG. 14, a system for positioning a sound source by a robot includes:

several sound source acquisition apparatuses 10 orientated to different directions, configured to respectively acquire sound source signals;

a monitoring unit 20, configured to monitor a plurality of sound source signals acquired by the sound source acquisition apparatuses;

a converting unit 30, configured to, when sound intensities of some sound source signals reach a predetermined sound intensity threshold, convert analog signals of the sound source signals with the sound intensities being greater than the predetermined sound intensity threshold into to-be-processed digital signals corresponding to the sound source signals;

a calculating unit 40, configured to respectively calculate actual power spectrums of the to-be-processed digital signals corresponding to the sound source signals, combine each two sound source signals of the sound source signals to obtain a plurality of sound signal combinations, calculate a delay between two sound source signals in each of the sound source signal combinations, and calculate coordinates of sound sources corresponding to the sound source signals according to the delays between the two sound source signals in the sound source signal combinations, a predetermined sound propagation speed and coordinates of the sound source acquisition apparatuses.

Specifically, the sound source acquisition apparatus may be a microphone, which may acquire sound source signals sent by a sound source in an ambient environment. Each microphone may acquire an analog signal of one sound source signal according to a predetermined sampling point quantity.

The sound source signals may be further processed only when the intensities of the sound source signal reach a predetermined sound intensity threshold. Firstly, analog signals of the sound source signals need to be converted into the corresponding to-be-processed digital signals for subsequent calculations.

Assume that four sound source acquisition apparatuses are configured, four sound source signals are present; in this case, based on a combination of each two sound source signals, six sound source signal combinations may be obtained, namely, AB, AC, AD, BC, BD and CD.

In this embodiment, the predetermined sound propagation speed is a propagation speed of sound waves in the medium air, and may be predefined in the robot; whereas the positions where the sound source acquisition apparatuses in the robot are fixed. Therefore, the coordinates of the sound source acquisition apparatuses are known, which may also be predefined in the robot. As such, more accurate coordinates of the sound source may be calculated according to the above disclosure.

In another embodiment of the present disclosure, based on the above embodiment, the calculating unit 40 is further configured to respectively calculate spectrums of the sound source signals according to the to-be-processed digital signals corresponding to the sound source signals, and respectively calculate actual power spectrums of the sound source signals according to the spectrums of the sound source signals.

Specifically, the calculation formula may be referenced to the above method embodiment, which is not described herein any further.

In another embodiment of the present disclosure, based on the above embodiment, the calculating unit 40 is further configured to calculate a mutual power spectrum between the two sound source signals in each of the sound source signal combinations according to actual power spectrums of the two sound source signals in the sound source signal combinations, calculate a frame cross-correlation function between the two sound source signals in each of the sound source signal combinations according to the mutual power spectrums of the sound source signal combinations, and calculate a delay between the two sound source signals in each of the sound source signal combinations according to the frame cross-correlation functions between the two sound source signals in the sound source signal combinations.

Specifically, the calculation formula may be referenced to the above method embodiment, which is not described herein any further. A delay between two sound source signals in each of the sound source signal combinations is calculated using the corresponding formula.

Preferably, the calculating unit calculates the coordinates of the sound sources corresponding to the sound source signals using the following formulae:

(Xₖ−X)²+(Yₖ−Y)²+(Zₖ−Z)²=Ctₖ² (10)

τₚ=tₚₗ−tₚₘ (11)

wherein K sound source acquisition apparatus are configured, Xₖ represents X-coordinate of the k^{th} sound source acquisition apparatus of all the sound source acquisition apparatuses, Yₖ represents Y-coordinate of the k^{th} sound source acquisition apparatus of all the sound source acquisition apparatuses, Zₖ represents Z-coordinate of the k^{th} sound source acquisition apparatus of all the sound source acquisition apparatuses, k is a natural number and is not greater than the total number of sound source acquisition apparatuses, tₖ represents the time when the k^{th} sound source signal reaches a corresponding sound source acquisition apparatus;

C represents a predetermined sound propagation speed;

each two sound source signals of K sound source signals corresponding to the K sound source acquisition apparatuses are combined to obtain P sound source signal combinations, τₚ represents a delay between two sound source signals in the p^{th} sound source signal combination of the P sound source signal combinations, tₚₗ represents the time when one sound source signal in the p^{th} sound source signal combination of the P sound source signal combinations reaches a corresponding sound source acquisition apparatus, tₚₘ represents the time when the other sound source signal in the p^{th} sound source signal combination of the P sound source signal combinations reaches a corresponding sound source acquisition apparatus, and tₚₗ and tₚₘ correspondingly correspond to a tₖ; and

X represents X-coordinate of a sound source corresponding to the sound source signal, Y represents Y-coordinate of the sound source corresponding to the sound source signal, and Z represents Z-coordinate of the sound source corresponding to the sound source signal.

Specifically, the coordinates of the sound sources may be calculated according to the delay, the coordinates of the sound source acquisition apparatuses and the predetermined sound propagation speed, thereby implementing more accurate positioning.

In another embodiment of the present disclosure, based on the above embodiment, as illustrated in FIG. 15, the calculating unit 40 is further configured to calculate an average power spectrum intensity of the actual power spectrum of each of the sound source signals to obtain the average power spectrum intensities corresponding to all the sound source signals; and

the system further includes:

a ranking unit 50, configured to rank the average power spectrum intensities corresponding to all the sound source signals; and

an estimating unit 60, configured to estimate direction information of the sound source according to the ranking of the average power spectrum intensities corresponding to all the sound source signals.

Specifically, after the actual power spectrums of the sound source signals are calculated, an average power spectrum intensity corresponding to each sound source signal may be calculated according to the actual power spectrums, such that the sound source signals are ranked according to the average power spectrum intensities thereof to estimate the direction information of the sound source.

Preferably, the system further includes: a reporting unit 70, configured to determine position information of the sound source according to the estimated direction information and the calculated coordinates, and report the position information to a head expression control board.

Specifically, after the coordinates are calculated and the direction information is estimated, the coordinates and the direction information may be reported as position information. Due to connection to the head expression control board, the position information may be reported to the head expression information, such that the robot performs subsequent actions.

The above embodiments are merely used to illustrate the technical solutions of the present disclosure, instead of limiting the protection scope of the present disclosure. Any modification, equivalent replacement, or improvement made without departing from the spirit and principle of the present disclosure should fall within the protection scope defined by the appended claims of the present disclosure.

What is claimed is:

1. A method for positioning a sound source by a robot, comprising the following steps:
S100: monitoring a plurality of sound source signals acquired by various sound source acquisition apparatuses;
S200: when sound intensities of at least one of the sound source signals reach a predetermined sound intensity threshold, converting analog signals of the sound source signals with the sound intensities being greater than the predetermined sound intensity threshold into to-be-processed digital signals corresponding to the sound source signals;
S300: respectively calculating actual power spectrums of the to-be-processed digital signals corresponding to the sound source signals;
S400: combining each two sound source signals of the sound source signals to obtain a plurality of sound signal combinations;
S500: calculating a delay between two sound source signals in each of the sound source signal combinations; and
S600: calculating coordinates of sound sources corresponding to the sound source signals according to the delays between the two sound source signals in the sound source signal combinations, a predetermined sound propagation speed and coordinates of the various sound source acquisition apparatuses.

2. The method for positioning a sound source by a robot according to claim 1, wherein step S300 comprises the following steps:
S310: respectively calculating spectrums of the sound source signals according to the to-be-processed digital signals corresponding to the sound source signals; and
S320: respectively calculating actual power spectrums of the sound source signals according to the spectrums of the sound source signals.

3. The method for positioning a sound source by a robot according to claim 2, wherein
in step S310, the spectrum of one of the sound source signals is calculated using the following formula:
X(n)=a₀*s(n)+a₁*s(n−1)+ . . . +aₙ₋₁*s(n−N−1) (1);
wherein in formula (1), N represents a predetermined sampling point quantity corresponding to one of the sound source signals, s(n) represents a to-be-processed digital signal corresponding to one of the sound source signals corresponding to the n^{th} sampling point, X(n) is a filter signal obtained after FIR filtering is performed for the to-be-processed digital signal corresponding to one of the sound source signals corresponding to the n^{th} sampling point, and a₀-aₙ₋₁ represents n predetermined filter coefficients;
$$\begin{matrix}W ( n ) = \{ \begin{matrix}0.54 - 0.46 cos ( 2 π \frac{n}{N - 1} ) , 0 \leq n \leq ( N - 1 ) \\ 0 , n = else\end{matrix} ; & ( 2 ) \\ {X}_{N} ( n ) = X ( n ) ⋆ W ( n ) ; & ( 3 )\end{matrix}$$
wherein in formula (2) and formula (3), W(n) represents a window function, X(n) represents a filter signal obtained after FIR filtering is performed for the to-be-processed digital signal corresponding to one of the sound source signals corresponding to the n^{th} sampling point, N represents a predetermined sampling point quality corresponding to one of the sound source signals, and X_{N}(n) represents a finite-length filter signal obtained after windowing is performed for the filter signal corresponding to the n^{th} sampling point in one of the sound source signals;
$${X}_{N} ( {e}^{i ω} ) = {\sum }_{n = 0}^{N - 1} {x}_{N} ( n ) {e}^{- i ω n} ; \qquad ( 4 )$$
wherein in formula (4), X_{N}(n) represents a finite-length filter signal obtained after windowing is performed for the filter signal corresponding to the n^{th} sampling point in one of the sound source signals, and X_{N}(e^{iω}) represents a spectrum corresponding to one of the sound source signals;
in step S320, the actual power spectrum of one of the sound source signals is calculated using the following formula:
$${S}_{x} ( {e}^{i ω} ) = \frac{1}{N} {\vert {X}_{N} ( {e}^{i ω} ) \vert}^{2} ; \qquad ( 5 )$$
wherein in formula (5), N represents a predetermined sampling point quality corresponding to one of the sound source signals, X_{N}(e^{iω}) represents a spectrum corresponding to one of the sound source signals, and Sₓ(e^{iω}) represents an actual power spectrum corresponding to one of the sound source signals.

4. The method for positioning a sound source by a robot according to claim 1, wherein step S500 comprises the following steps:
S510: calculating a mutual power spectrum between the two sound source signals in each of the sound source signal combinations according to actual power spectrums of the two sound source signals in the sound source signal combinations;
S520: calculating a frame cross-correlation function between the two sound source signals in each of the sound source signal combinations according to the mutual power spectrums of the sound source signal combinations; and
S530: calculating a delay between the two sound source signals in each of the sound source signal combinations according to the frame cross-correlation functions between the two sound source signals in the sound source signal combinations.

5. The method for positioning a sound source by a robot according to claim 4, wherein in step S510, the mutual power spectrum between the two sound source signals in each of the sound source signal combinations is calculated using the following formula:
$${G}_{lm} ( ω ) = {X}_{l} ( ω ) {X}_{m}^{*} ( ω ) = {abG}_{ss} ( ω ) {e}^{- j ω ( {τ}_{l} - {τ}_{m} )} + {G}_{{n}_{l} {n}_{{ }_{m}}} ( ω ) ; \qquad ( 6 )$$
wherein in formula (6), Xₗ(ω) represents an actual power spectrum of one sound source signal in one of the sound source signal combinations, Xₘ*(ω) represents an actual power spectrum of another sound source signal in the sound source signal combinations, Gₗₘ (ω) represents a mutual power spectrum between two sound source signals in the sound source signal combination, Gₛₛ(ω)e^{-jω(τ}^{ₗ}^{-τ}^{ₘ}⁾ represents a power spectrum between two sound source signals in the sound source signal combination,
$${G}_{{n}_{l} {n}_{{ }_{m}}} ( ω )$$
represents a mutual spectrum of an additive noise signal of two sound source signals in the sound source signal combination, and a and b are predetermined constants.

6. The method for positioning a sound source by a robot according to claim 4, wherein in step S520, the frame cross-correlation function the two sound source signals in each of the sound source signal combinations is calculated using the following formula:
$${R}_{lm}^{g} ( τ ) = {\int }_{∞}^{∞} φ ( ω ) {G}_{lm} ( ω ) {e}^{j ω τ} d ω ; \qquad ( 7 )$$
wherein in formula (7), φ(ω) represents a weighting function, Rₗₘ^{g}(τ) represents a frame cross-correlation function between two sound source signals in one of the sound source signal combinations, and Gₗₘ (ω) represents a mutual power spectrum between two sound source signals of the sound source signal combination.

7. The method for positioning a sound source by a robot according to claim 6, wherein in step S530, the delay between the two sound source signals in each of the sound source signal combinations is calculated using the following formula:
φ(ω)=1/|Gₗₘ(ω)| (8);
wherein in formula (8), Gₗₘ(ω) represents a mutual power spectrum between two sound source signals in each of the sound source signal combinations;
according to the φ(ω) weighting function, the frame cross-correlation function of each of the sound source signal combinations is:
$${R}_{lm}^{g} ( τ ) = {\int }_{∞}^{∞} \frac{{G}_{lm} ( ω )}{\vert {G}_{lm} ( ω ) \vert} {e}^{j ω τ} d ω = ab δ ( τ - ( {τ}_{l} - {τ}_{m} ) ) ; \qquad ( 9 )$$
wherein in formula (9), a and b are predetermined constants, δ(τ−(τₗ−τₘ)) represents a delay function between two sound source signals in each of the sound source signal combinations, τ represents a delay between two sound source signals in each of the sound source signal combinations, τₗ represents the time when one sound source signal in the sound source signal combination reaches a corresponding sound source acquisition apparatus, τₘ represents the time when the other sound source signal in the sound source signal combination reaches a corresponding sound source acquisition apparatus, and when the frame cross-correlation function takes a peak value, τ=τₗ−τₘ.

8. The method for positioning a sound source by a robot according to claim 7, wherein in step S600, the coordinates of the sound sources corresponding to the sound source signals are calculated using the following formulae:
(Xₖ−X)²+(Yₖ−Y)²+(Zₖ−Z)²=Ctₖ² (10);
τₚ=tₚₗ−tₚₘ (11);
wherein K sound source acquisition apparatus are configured, Xₖ represents X-coordinate of the k^{th} sound source acquisition apparatus of all the sound source acquisition apparatuses, Yₖ represents Y-coordinate of the k^{th} sound source acquisition apparatus of all the sound source acquisition apparatuses, Zₖ represents Z-coordinate of the k^{th} sound source acquisition apparatus of all the sound source acquisition apparatuses, k is a natural number and is not greater than the total number of sound source acquisition apparatuses, tₖ represents the time when the k^{th} sound source signal reaches a corresponding sound source acquisition apparatus;
C represents a predetermined sound propagation speed;
each two sound source signals of K sound source signals corresponding to the K sound source acquisition apparatuses are combined to obtain P sound source signal combinations, τₚ represents a delay between two sound source signals in the p^{th} sound source signal combination of the P sound source signal combinations, tₚₗ represents the time when one sound source signal in the p^{th} sound source signal combination of the P sound source signal combinations reaches a corresponding sound source acquisition apparatus, tₚₘ represents the time when the other sound source signal in the p^{th} sound source signal combination of the P sound source signal combinations reaches a corresponding sound source acquisition apparatus, and tₚₗ and tₚₘ correspondingly correspond to a tₖ; and
X represents X-coordinate of a sound source corresponding to the sound source signal, Y represents Y-coordinate of the sound source corresponding to the sound source signal, and Z represents Z-coordinate of the sound source corresponding to the sound source signal.

9. The method for positioning a sound source by a robot according to claim 1, wherein upon step S300, the method further comprises the following steps:
S700: calculating an average power spectrum intensity of the actual power spectrum of each of the sound source signals to obtain the average power spectrum intensities corresponding to all the sound source signals;
S710: ranking the average power spectrum intensities corresponding to all the sound source signals; and
S720: estimating direction information of the sound source according to the ranking of the average power spectrum intensities corresponding to all the sound source signals.

10. The method for positioning a sound source by a robot according to claim 9, wherein upon step S600 and step S720, the method further comprises the following steps:
S800: determining position information of the sound source according to the estimated direction information and the calculated coordinates; and
S810: reporting the position information.

11. A system for positioning a sound source by a robot, comprising:
a plurality of sound source acquisition apparatuses orientated to different directions, configured to acquire sound source signals, respectively;
a monitoring unit, configured to monitor a plurality of sound source signals acquired by the sound source acquisition apparatuses;
a converting unit, configured to, when sound intensities of at least one of sound source signals reach a predetermined sound intensity threshold, convert analog signals of the sound source signals with the sound intensities being greater than the predetermined sound intensity threshold into to-be-processed digital signals corresponding to the sound source signals;
a calculating unit, configured to respectively calculate actual power spectrums of the to-be-processed digital signals corresponding to the sound source signals, combine each two sound source signals of the sound source signals to obtain a plurality of sound signal combinations, calculate a delay between two sound source signals in each of the sound source signal combinations, and calculate coordinates of sound sources corresponding to the sound source signals according to the delays between the two sound source signals in the sound source signal combinations, a predetermined sound propagation speed and coordinates of the sound source acquisition apparatuses.

12. The system for positioning a sound source by a robot according to claim 11, wherein
the calculating unit is further configured to respectively calculate spectrums of the sound source signals according to the to-be-processed digital signals corresponding to the sound source signals, and respectively calculate actual power spectrums of the sound source signals according to the spectrums of the sound source signals.

13. The system for positioning a sound source by a robot according to claim 12, wherein
the calculating unit calculates the spectrum of one of the sound source signals using the following formula:
X(n)=a₀*s(n)+a₁*s(n−1)+ . . . +aₙ₋₁*s(n−N−1) (1);
wherein in formula (1), N represents a predetermined sampling point quantity corresponding to one of the sound source signals, s(n) represents a to-be-processed digital signal corresponding to one of the sound source signals corresponding to the n^{th} sampling point, X(n) is a filter signal obtained after FIR filtering is performed for the to-be-processed digital signal corresponding to one of the sound source signals corresponding to the n^{th} sampling point, and a₀-aₙ₋₁ represents n predetermined filter coefficients;
$$\begin{matrix}W ( n ) = \{ \begin{matrix}0.54 - 0.46 cos ( 2 π \frac{n}{N - 1} ) , 0 \leq n \leq ( N - 1 ) \\ 0 , n = else\end{matrix} ; & ( 2 ) \\ {X}_{N} ( n ) = X ( n ) ⋆ W ( n ) ; & ( 3 )\end{matrix}$$
wherein in formula (2) and formula (3), W(n) represents a window function, X(n) represents a filter signal obtained after FIR filtering is performed for the to-be-processed digital signal corresponding to one of the sound source signals corresponding to the n^{th} sampling point, N represents a predetermined sampling point quality corresponding to one of the sound source signals, X_{N}(n) represents a finite-length filter signal obtained after windowing is performed for the filter signal corresponding to the n^{th} sampling point in one of the sound source signals;
$${X}_{N} ( {e}^{i ω} ) = {\sum }_{n = 0}^{N - 1} {x}_{N} ( n ) {e}^{- i ω n} ; \qquad ( 4 )$$
wherein in formula (4), X_{N}(n) represents a finite-length filter signal obtained after windowing is performed for the filter signal corresponding to the n^{th} sampling point in one of the sound source signals, and X_{N}(e^{iω}) represents a spectrum corresponding to one of the sound source signals;
the calculating unit calculates the actual power spectrum of one of the sound source signals using the following formula:
$${S}_{x} ( {e}^{i ω} ) = \frac{1}{N} {\vert {X}_{N} ( {e}^{i ω} ) \vert}^{2} ; \qquad ( 5 )$$
wherein in formula (5), N represents a predetermined sampling point quality corresponding to one of the sound source signals, X_{N}(e^{iω}) represents a spectrum corresponding to one of the sound source signals, and Sₓ(e^{iω}) represents an actual power spectrum corresponding to one of the sound source signals.

14. The system for positioning a sound source by a robot according to claim 11, wherein
the calculating unit is further configured to calculate a mutual power spectrum between the two sound source signals in each of the sound source signal combinations according to actual power spectrums of the two sound source signals in the sound source signal combinations, calculate a frame cross-correlation function between the two sound source signals in each of the sound source signal combinations according to the mutual power spectrums of the sound source signal combinations, and calculate a delay between the two sound source signals in each of the sound source signal combinations according to the frame cross-correlation functions between the two sound source signals in the sound source signal combinations.

15. The system for positioning a sound source by a robot according to claim 14, wherein
the calculating unit calculates the mutual power spectrum between the two sound source signals in each of the sound source signal combinations using the following formula:
$${G}_{lm} ( ω ) = {X}_{l} ( ω ) {X}_{m}^{*} ( ω ) = {abG}_{ss} ( ω ) {e}^{- j ω ( {τ}_{l} - {τ}_{m} )} + {G}_{{n}_{l} {n}_{{ }_{m}}} ( ω ) ; \qquad ( 6 )$$
wherein in formula (6), Xₗ(ω) represents an actual power spectrum of one sound source signal in one of the sound source signal combination, Xₘ*(ω) represents an actual power spectrum of another sound source signal in the sound source signal combinations, Gₗₘ(ω) represents a mutual power spectrum between two sound source signals in the sound source signal combination, Gₛₛ(ω)e^{-jω(τ}^{ₗ}^{-τ}^{ₘ}⁾ represents a power spectrum between two sound source signals in the sound source signal combination,
$${G}_{{n}_{l} {n}_{{ }_{m}}} ( ω )$$
represents a mutual spectrum of an additive noise signal of two sound source signals in the sound source signal combination, and a and b are predetermined constants.

16. The system for positioning a sound source by a robot according to claim 14, wherein
the calculating unit calculates the frame cross-correlation function the two sound source signals in each of the sound source signal combinations using the following formula:
$${R}_{lm}^{g} ( τ ) = {\int }_{∞}^{∞} φ ( ω ) {G}_{lm} ( ω ) {e}^{j ωτ} d ω ; \qquad ( 7 )$$
wherein in formula (7), φ(ω) represents a weighting function, Rₗₘ^{g}(τ) represents a frame cross-correlation function between two sound source signals of one of the sound source signal combinations, and Gₗₘ(ω) represents a mutual power spectrum between two sound source signals of the sound source signal combination.

17. The system for positioning a sound source by a robot according to claim 16, wherein
the calculating unit calculates the delay between the two sound source signals in each of the sound source signal combinations using the following formula:
φ(ω)=1/|Gₗₘ(ω)| (8);
wherein in formula (8), Gₗₘ(ω) represents a mutual power spectrum between two sound source signals in each of the sound source signal combinations;
according to the φ(ω) weighting function, the frame cross-correlation function of each of the sound source signal combinations is:
$${R}_{lm}^{g} ( τ ) = {\int }_{∞}^{∞} \frac{{G}_{lm} ( ω )}{\vert {G}_{lm} ( ω ) \vert} {e}^{j ωτ} d ω = ab δ ( τ - ( {τ}_{l} - {τ}_{m} ) ) ; \qquad ( 9 )$$
wherein in formula (9), a and b are predetermined constants, δ(τ−(τₗ−τₘ)) represents a delay function between two sound source signals in each of the sound source signal combinations, τ represents a delay between two sound source signals in each of the sound source signal combinations, τₗ represents the time when one sound source signal in the sound source signal combination reaches a corresponding sound source acquisition apparatus, τₘ represents the time when the other sound source signal in the sound source signal combination reaches a corresponding sound source acquisition apparatus, and when the frame cross-correlation function takes a peak value, τ=τₗ−τₘ.

18. The system for positioning a sound source by a robot according to claim 17, wherein
the calculating unit calculates the coordinates of the sound sources corresponding to the sound source signals using the following formulae:
(Xₖ−X)²+(Yₖ−Y)²+(Zₖ−Z)²=Ctₖ² (10);
τₚ=tₚₗ−tₚₘ (11);
wherein K sound source acquisition apparatus are configured, Xₖ represents X-coordinate of the k^{th} sound source acquisition apparatus of all the sound source acquisition apparatuses, Yₖ represents Y-coordinate of the k^{th} sound source acquisition apparatus of all the sound source acquisition apparatuses, Zₖ represents Z-coordinate of the k^{th} sound source acquisition apparatus of all the sound source acquisition apparatuses, k is a natural number and is not greater than the total number of sound source acquisition apparatuses, tₖ represents the time when the k^{th} sound source signal reaches a corresponding sound source acquisition apparatus;
C represents a predetermined sound propagation speed;
each two sound source signals of K sound source signals corresponding to the K sound source acquisition apparatuses are combined to obtain P sound source signal combinations, τₚ represents a delay between two sound source signals in the p^{th} sound source signal combination of the P sound source signal combinations, tₚₗ represents the time when one sound source signal in the p^{th} sound source signal combination of the P sound source signal combinations reaches a corresponding sound source acquisition apparatus, tₚₘ represents the time when the other sound source signal in the p^{th} sound source signal combination of the P sound source signal combinations reaches a corresponding sound source acquisition apparatus, and tₚₗ and tₚₘ correspondingly correspond to a tₖ; and
X represents X-coordinate of a sound source corresponding to the sound source signal, Y represents Y-coordinate of the sound source corresponding to the sound source signal, and Z represents Z-coordinate of the sound source corresponding to the sound source signal.

19. The system for positioning a sound source by a robot according to claim 11, wherein
the calculating unit is further configured to calculate an average power spectrum intensity of the actual power spectrum of each of the sound source signals to obtain the average power spectrum intensities corresponding to all the sound source signals; and
the system further comprises:
a ranking unit, configured to rank the average power spectrum intensities corresponding to all the sound source signals; and
an estimating unit, configured to estimate direction information of the sound source according to the ranking of the average power spectrum intensities corresponding to all the sound source signals.

20. The system for positioning a sound source by a robot according to claim 19, further comprising:
a reporting unit, configured to determine position information of the sound source according to the estimated direction information and the calculated coordinates, and report the position information.
